(19) United States
(12) Patent Application Publication
(10) Pub. No.: US 2024/0406348 A1
(43) Pub. Date: Dec. 5, 2024

(54) VIDEO CONFERENCING WITH FOOD DELIVERY VOUCHERS

(71) Applicants: Vishal Patel, Surrey (CA); Kenny Shimokura, Burnaby (CA)

(72) Inventors: Vishal Patel, Surrey (CA); Kenny Shimokura, Burnaby (CA)

(21) Appl. No.: 18/203,232

(22) Filed: May 30, 2023

(51) Int. Cl. H04N 7/15; G06Q 30/0207

(52) U.S. Cl. CPC H04N 7/152; G06Q 30/0239

(57) ABSTRACT

Systems and methods of providing video conferencing services with vouchers for real-world delivery at the time of the event are disclosed.

### CROSS-REFERENCE TO RELATED APPLICATIONS

The present application claims priority to U.S. Provisional Application No. 63/235,547filed Mar. 30, 2022, titled “VIDEO CONFERENCING WITH FOOD DELIVERY VOUCHERS,” which is hereby incorporated by reference in its entirety.

### TECHNICAL FIELD

Embodiments of the invention relate to systems and methods for online video conferencing platforms with vouchers for food delivery at the time of the conference.

### BACKGROUND

Videoconferencing has been a popular way for people to meet virtually and attend presentations, network, discuss topics, and otherwise enjoy the company of colleagues, friends, and family members. The recent worldwide COVID-19 pandemic has rapid expanded the usage of such tools and mainstreamed them for businesses that allow or require their employees to work from home. Technological developments pushed by companies such as Meta (Facebook) promise to further expand and improve the virtual meeting experience for users. Unfortunately, these virtual environment do not provide all of the staples and amenities of real-world, physical conferences, such as food, drinks, and take-home swag.

Thus, it would be beneficial and needs exist for businesses and conference organizers to improve the experience of users with food, beverage, and item deliveries at the time a virtual conference is being held.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The example embodiments provided herein relate to and disclose systems and methods for a customized video conferencing platform that provides managers with the ability to include food vouchers and/or delivery, providing for virtual lunch/dinner meetings. These platforms can provide convenient systems to conduct virtual meetings and send food and drinks to invitees. Additionally, users can take advantage of simplified billing and meeting organization, which may otherwise need to be manually conducted or across multiple applications and platforms. These features allow user organizers to send meeting invitations, set vouchers for food and drinks, schedule dates and times, and communicate over videoconference while sharing a virtual meal.

Games, centralized billing, gift card delivery, scheduling, customized questions, live e-cards (e.g., users sending vouchers and gift cards with mini-video conferences and labeled as live greetings/e-cards) and other features are also contemplated and included herein.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRA WINGS

A more complete understanding of the embodiments, and the attendant advantages and features thereof, will be more readily understood by references to the following detailed description when considered in conjunction with the accompanying drawings wherein:

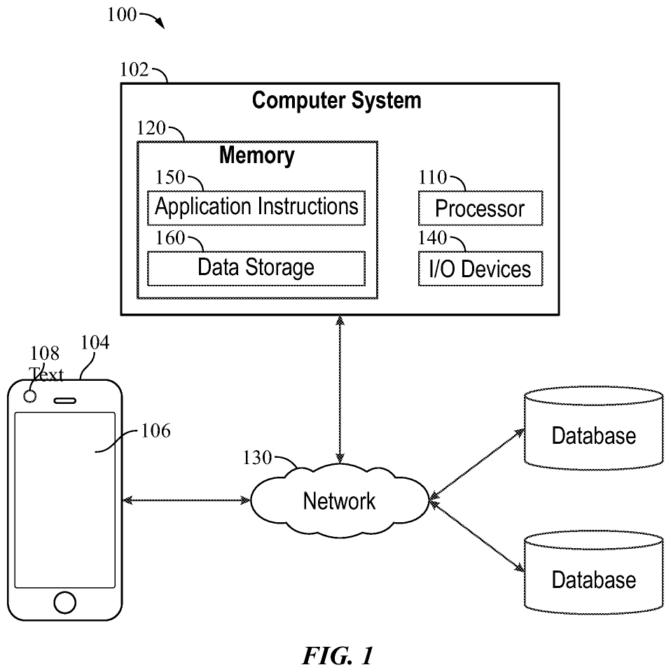

FIG. 1 illustrates a system architecture diagram, according to some embodiments;

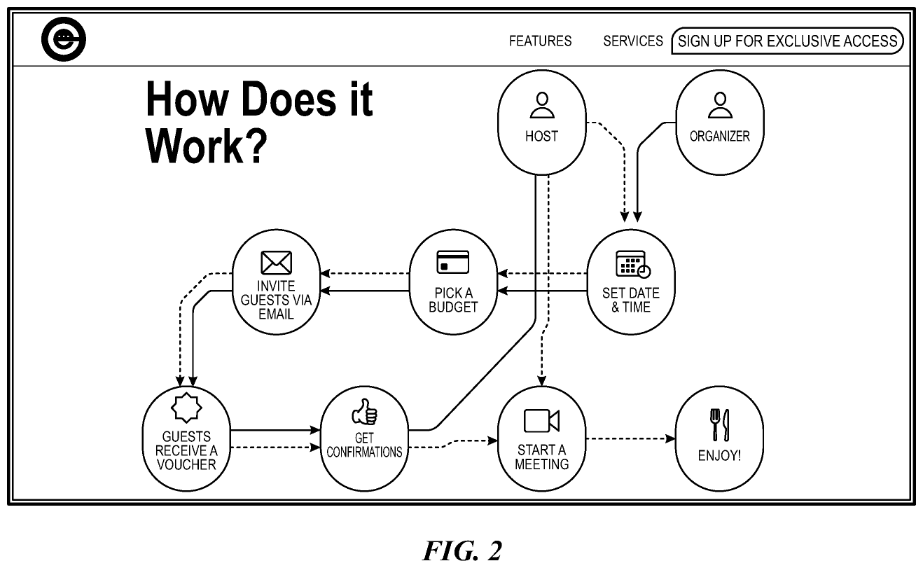

FIG. 2 illustrates a service operation flowchart, according to some embodiments;

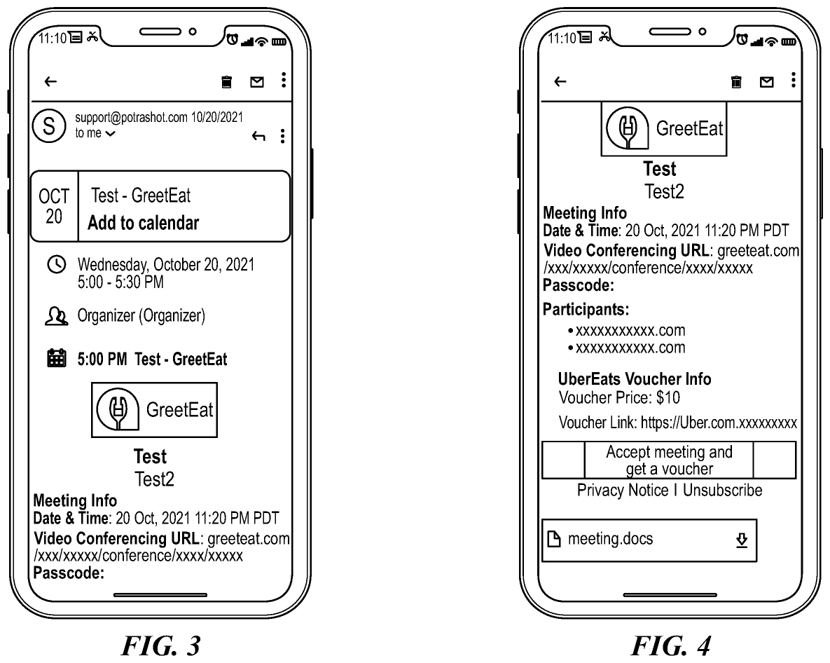

FIG. 3 illustrates a user interface for a mobile device including an invitation for guests, according to some embodiments;

FIG. 4 illustrates a user interface for a mobile device including a videoconferencing link, according to some embodiments;

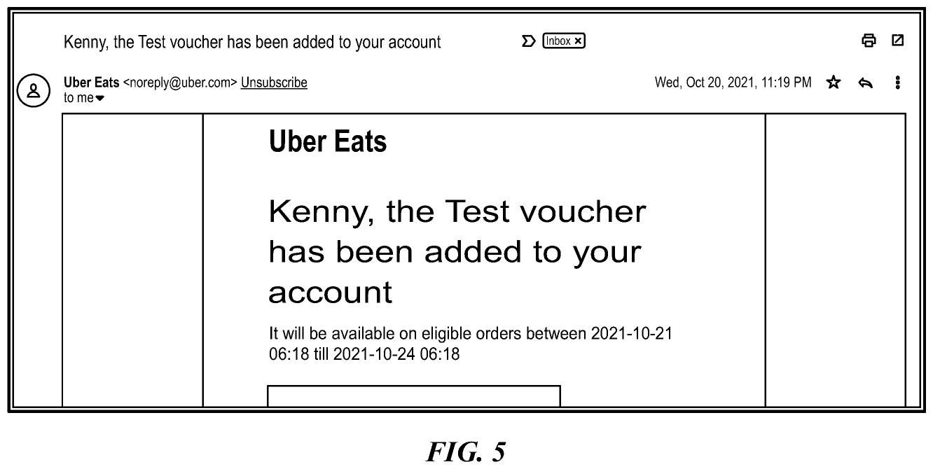

FIG. 5 illustrates a user interface voucher delivery notification, according to some embodiments;

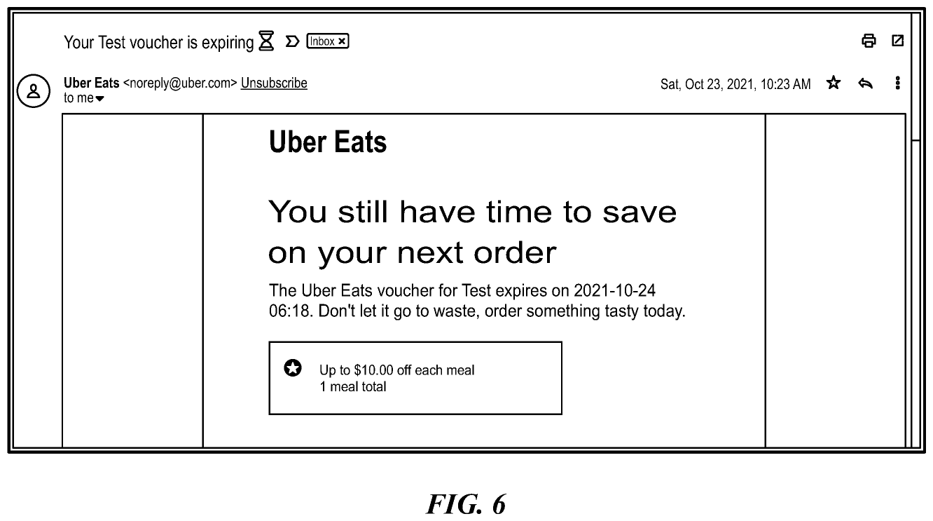

FIG. 6 illustrates a user interface voucher delivery notification expiry reminder, according to some embodiments;

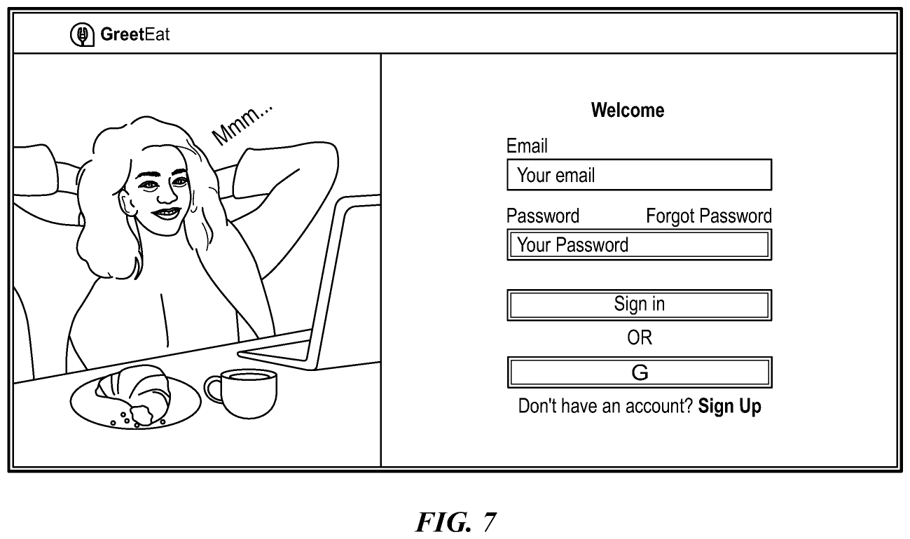

FIG. 7 illustrates a user interface login page, according to some embodiments;

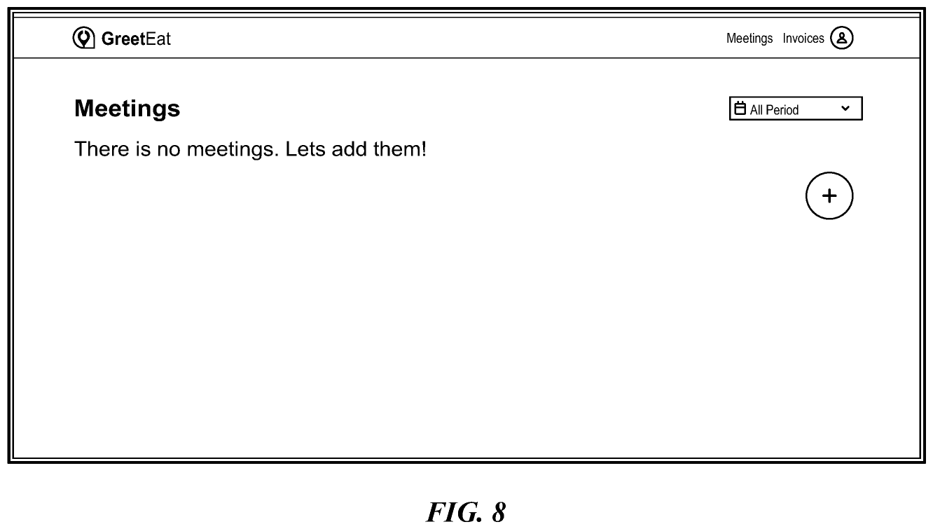

FIG. 8 illustrates a user interface meeting list page, according to some embodiments;

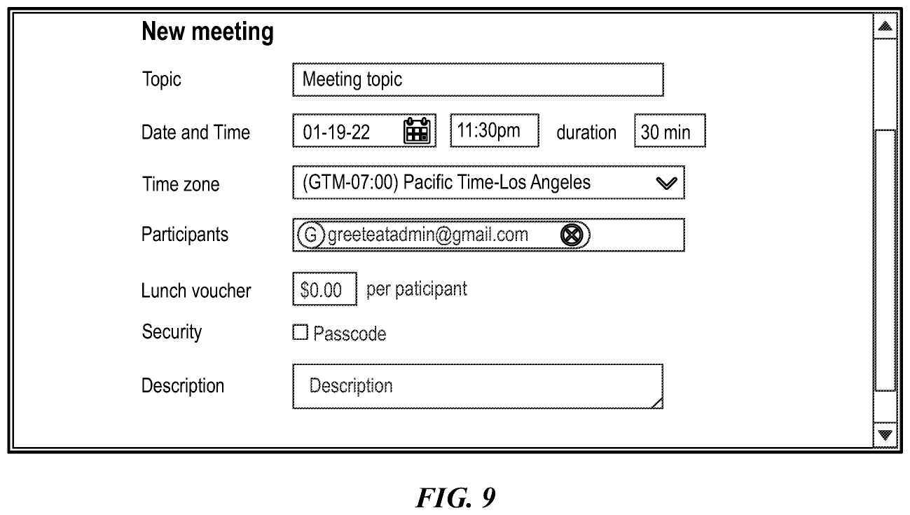

FIG. 9 illustrates a user interface meeting creation page, according to some embodiments;

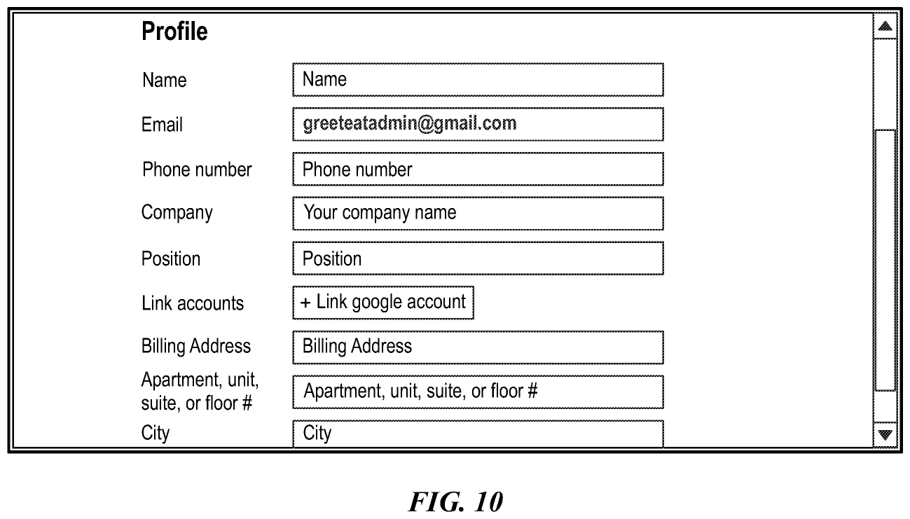

FIG. 10 illustrates a user interface profile page, according to some embodiments;

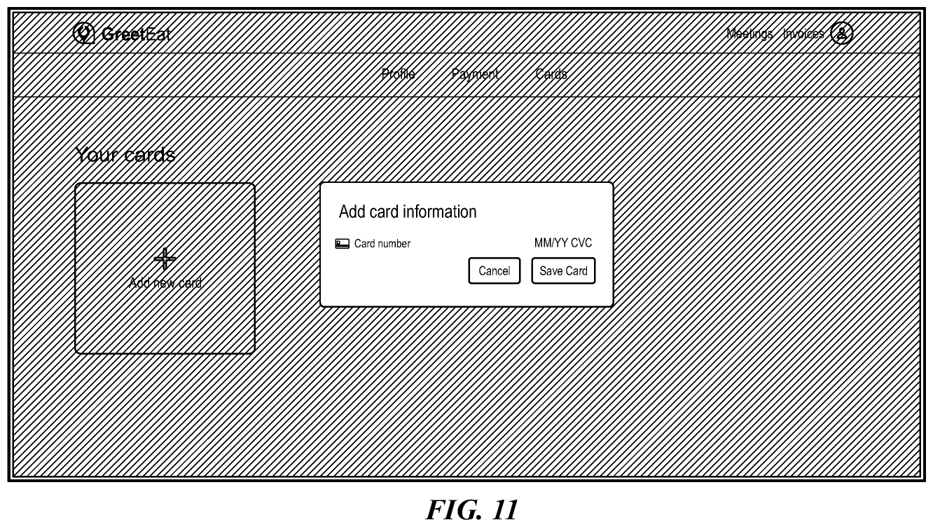

FIG. 11 illustrates a user interface payment information page, according to some embodiments;

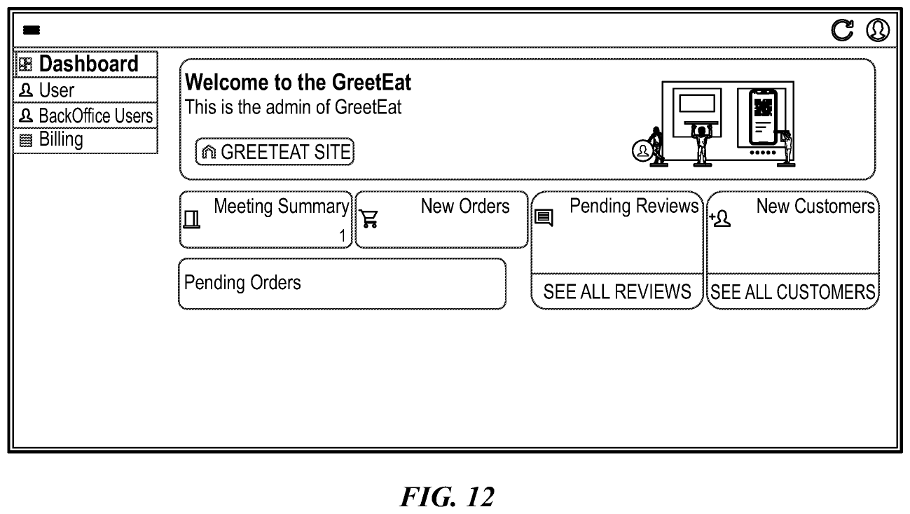

FIG. 12 illustrates a user interface administrator dashboard meetings display page, according to some embodiments;

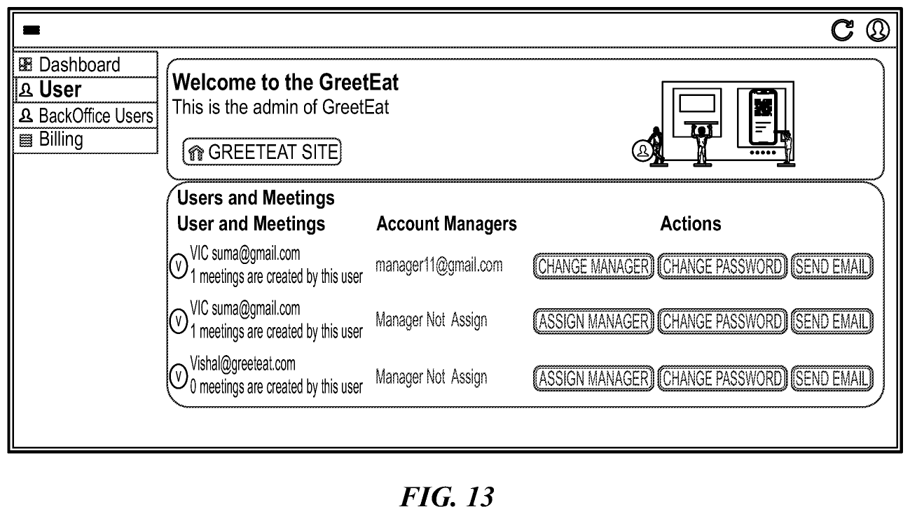

FIG. 13 illustrates a user interface current user and account manager assignment page, according to some embodiments;

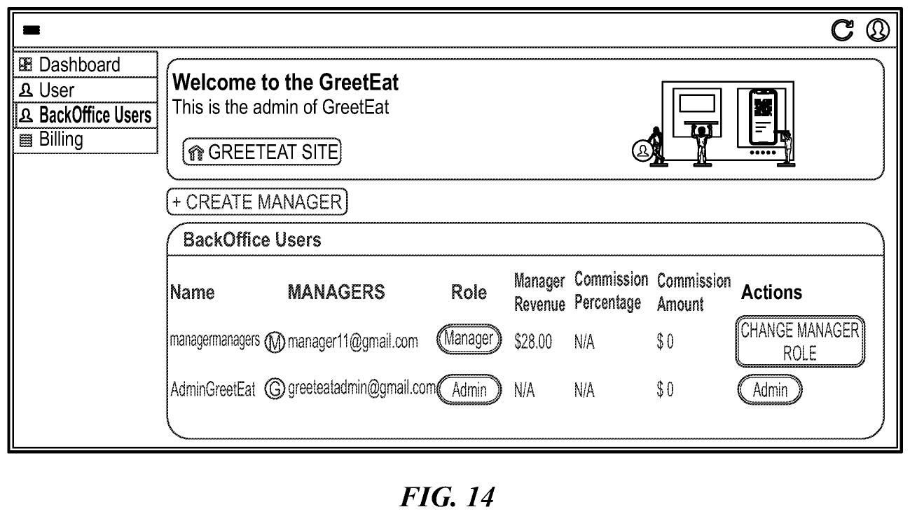

FIG. 14 illustrates a user interface account manager commission page, according to some embodiments;

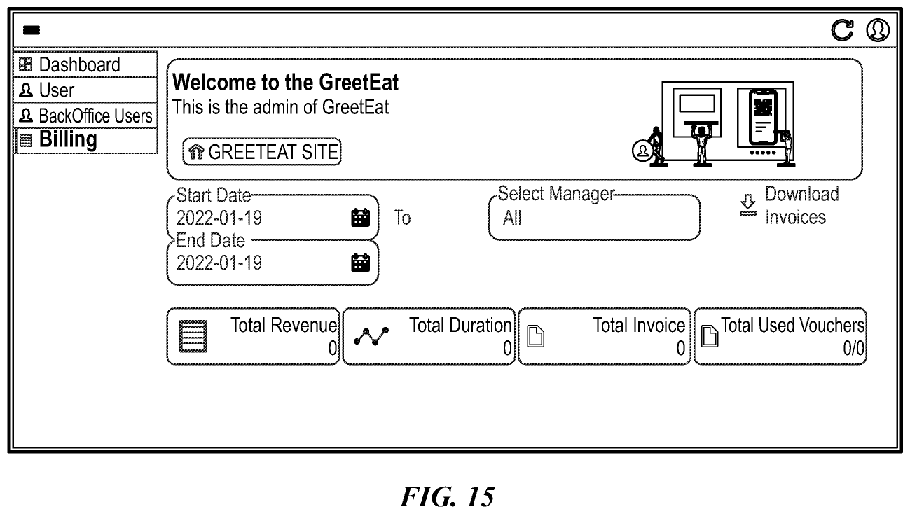

FIG. 15 illustrates a user interface billing page, according to some embodiments;

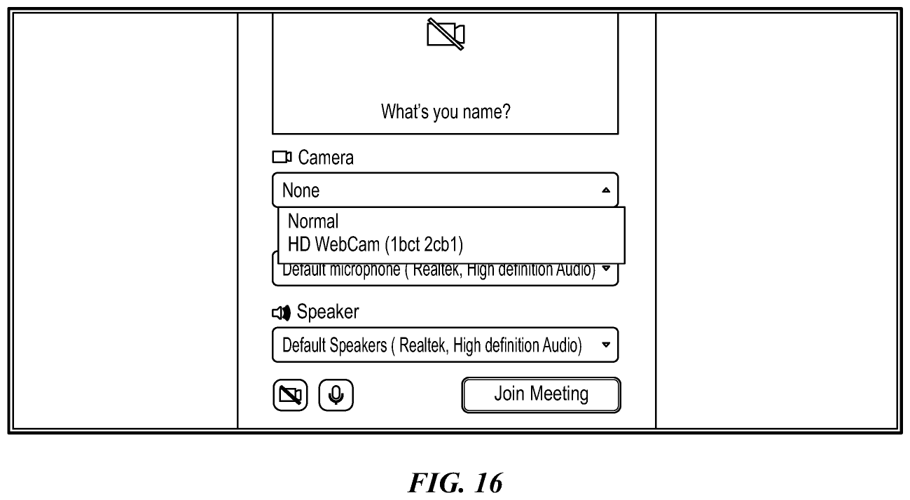

FIG. 16 illustrates a user interface conference equipment selection, according to some embodiments;

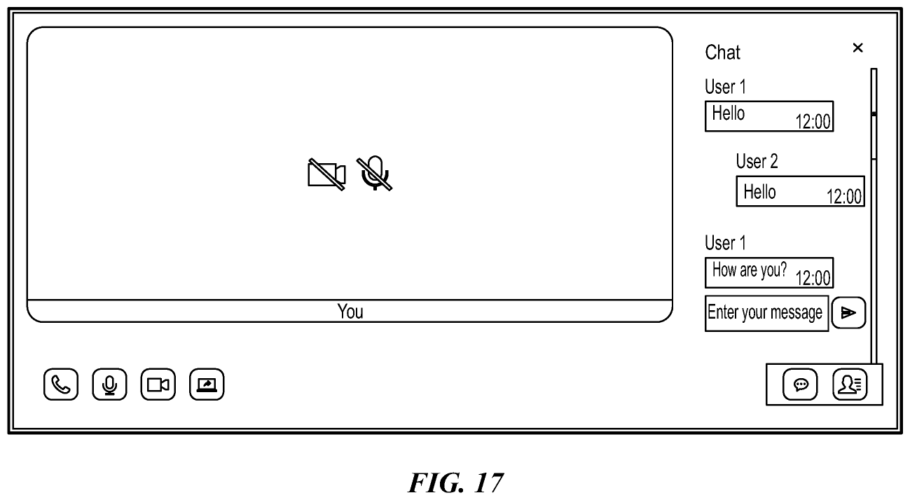

FIG. 17 illustrates a user interface conference meeting display page, according to some embodiments;

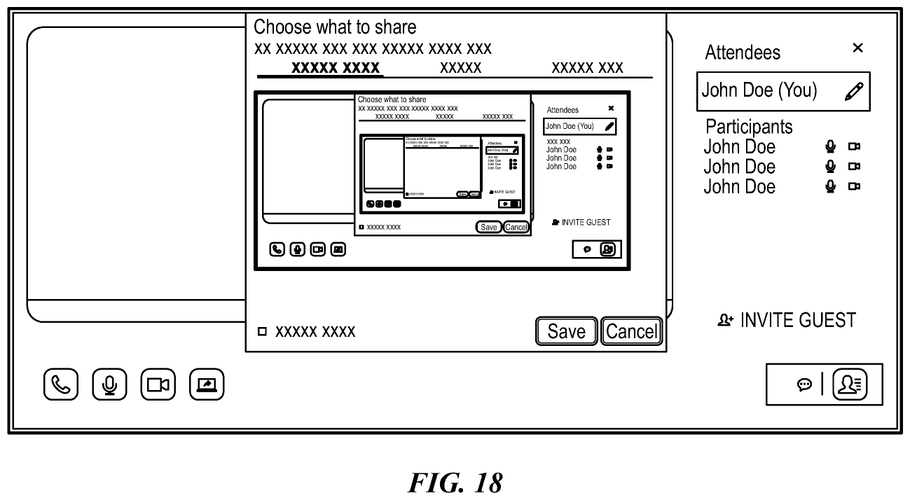

FIG. 18 illustrates a user interface presentation mode page, according to some embodiments; and

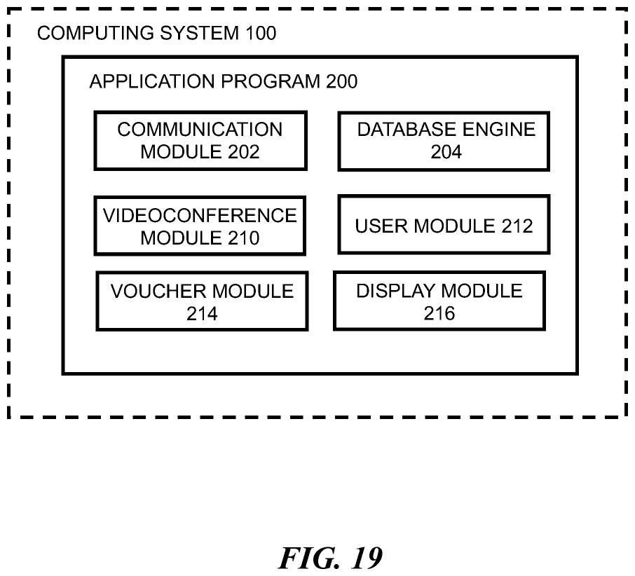

FIG. 19 illustrates an application program in communication with the computer system, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated.

Processors 110 suitable for the execution of a computer program include both general and special purpose microprocessors and any one or more processors of any digital computing device.

The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANS), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if computer system 102 is mobile.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device 102.

As shown in the example embodiment, a mobile computing device 104 can also be communicatively coupled with and exchange data with network 130. Those in the art will understand that mobile computing device 104 can include some or all of the same or similar components as computer system 102, coupled to constitute an operable device. Mobile computing device 104 can be a personal digital assistant (PDA), smartphone, tablet computer, laptop, wearable computing device such as a smartwatch or smart glasses, or other device that includes one or more user interface 106, such as a touchscreen and/or audio input/output and/or other display and user input components. Mobile computing device 104 can also include one or more image capturing or reading component 108 (e.g., a digital camera, scanner, or others) and associated structures and elements operatively coupled to at least one processor and memory of the mobile computing device. Such image capturing component 108 can be operable to capture an image of a label and/or code (e.g., a quick response (QR) code or others) automatically or upon one or more user input commands.

Also shown in FIG. 1 are one or more database(s). These databases can be locally stored in memory or remotely stored in memory that is accessible by computer system 102 via network 130 and may be proprietary, public, or some combination thereof. These databases can also be third-party or system databases in some embodiments and may have one of any manner of structures, privacy measures, and other features and elements.

In this description, conference and meeting may be used interchangeably and generally have similar connotations.

FIG. 2 illustrates a service operation flowchart, according to some embodiments. As shown, users such as conference and/or meeting organizers and/or hosts can discuss, select and/or set a time and date for a conference. One or both of these users can select, enter, choose, or otherwise input a budget for the meeting and then invite guests via email or other communication service. Guests can then receive a voucher for food, drink, decorations, and/or other meeting related expenses, e.g., via email attachment, third-party application notification, or in other manners. A confirmation can be sent back to the system if the recipient/guest selects an appropriate respond button. The host may be notified of such via the system. When the set time and date is near or occurs, the host can start the meeting. In some instances, the system may send one or more reminders to the host and/or guests that the meeting is upcoming and/or about to begin. When the meeting begins, the users can be notified. Delivery confirmation can also be sent to hosts and/or organizers in some embodiments.

In various embodiments, hosts and/or organizers can assign and/or pay the system on a per voucher transaction, per meeting transaction, per week, per month, per quarter, or other basis. Service fees for videoconference, audioconference, messaging conference, bandwidth, memory storage, and/or other basis in a similar manner.

In various embodiments, vouchers can be used with system connected vendors or suppliers, with third-party system integration (e.g., Uber Eats, DoorDash, or other delivery service), with particular restaurant partners, or otherwise. These vouchers can be selected or assigned based on subscription, individual meeting transaction or otherwise in various embodiments.

As shown, users can also select a features, services, sign up, or other button in a menu bar to view the associated information and/or sign-up (e.g., see FIG. 7 and associated description) with the system.

FIG. 3 illustrates a user interface for a mobile device including an invitation for guests, according to some embodiments. As shown, an invitation received via a computer network at, and displayed on, a meeting guest's mobile device can include the organizer's selected date, time, and host information, as well as others, as appropriate. One or more links to the meeting or access notes can be included that inform the guest about how to connect, dial-in, or otherwise access the meeting. These can also include access codes, passcodes, or other authentication or verification information in some embodiments. Links may go live before or immediately upon receipt by the guest, or they may become active within a certain time period immediately preceding the scheduled meeting start time (e.g., fifteen minutes before the meeting).

FIG. 4 illustrates a user interface for a mobile device including a videoconferencing link, according to some embodiments. As shown, the meeting link can be selected by a user. In some embodiments a participant list (e.g., name, username, contact information, and/or others) and/or meeting acceptance indicator can be displayed for review by the guest. Voucher information can also be displayed, including an amount. Selecting an accept voucher button or link to accept the voucher can cause the system to send or otherwise deposit the voucher amount into the user's account with the delivery service.

FIG. 5 illustrates a user interface voucher delivery notification, according to some embodiments. As shown, a user can receive a notification/confirmation message at their email or through another messaging service such as a social media account. This can include a description of the voucher information, amount, conference or meeting information, and time when the voucher will be active or otherwise successfully be added to their account.

FIG. 6 illustrates a user interface voucher delivery notification expiry reminder, according to some embodiments. As shown, a user can receive a notification/expiry message at their email or through another messaging service such as a social media account. This can include a description of the voucher information, amount, conference or meeting information, and time when the voucher will expire, be removed, or otherwise become inactive if the guest fails to use it for a delivery order.

FIG. 7 illustrates a user interface login page, according to some embodiments. As shown, a user device used to access the platform can be presented with a signup or login screen that allows them to enter account information such as an email address or username, a password, or third-party sign-on or login ability.

FIG. 8 illustrates a user interface meeting list page, according to some embodiments. As shown, the user device can display a list of one or more meetings, which can be sorted by time period, calendar date, time, or other manner. Meetings can also be added by users.

FIG. 9 illustrates a user interface meeting creation page, according to some embodiments. As shown, users can create a new meeting on the platform. The user can enter or select a title or topic for the meeting or conference, a date and time, a duration, a time zone, a voucher amount, security passcode or other authentication information (which can be automatically generated by the system in some instances for added security), a description of the voucher and/or meeting, or other information. The user can also select or enter participant information, such as email addresses, system accounts, or third-party account information for guests or participants.

FIG. 10 illustrates a user interface profile page, according to some embodiments. As shown, users can enter or select a name, email or contact information, phone number, company name, position, linked accounts such as a LinkedIn or Google account link, a billing, delivery, or other physical address, and other information.

FIG. 11 illustrates a user interface payment information page, according to some embodiments. As shown, users can enter or link to bank account information, credit or debit card information, cryptocurrency wallet, system account, or other payment mechanism.

FIG. 12 illustrates a user interface administrator dashboard meetings display page, according to some embodiments. As shown, back end administrator capabilities can include a dashboard tab, a user's tab, a back office or system administrator users tab, a billing tab, or others. Users can view a system platform homepage by selecting an appropriate link. The user can also view meeting summary information, new order information, pending meeting review information, new customer information, and/or others. Users can also refresh, go back, and view administrator profile information by selecting an appropriate button or link. Administrators can view by current date or select others date, view pending orders, or perform other actions.

FIG. 13 illustrates a user interface current user and account manager assignment page, according to some embodiments. As shown, a user's tab can allow administrators to view usernames and interactions with the platform. This can include the number of meetings the user has created the number of participants for a meeting, account manager contact information, and others. Administrators can also perform various actions by selecting buttons allowing them to change account manager information, change password information, contact the account manager via email or other contact means, or others.

FIG. 14 illustrates a user interface account manager commission page, according to some embodiments. As shown, users can create a manager for an account, change roles (e.g., manager, admin, or others), view manager revenue and commission percentages and amounts and set commissions, view accounts, and perform other actions.

FIG. 15 illustrates a user interface billing page, according to some embodiments. As shown, administrators can view and modify billing date ranges, view revenue, view meeting time, view total invoices, view user information, view total used vouchers, and others. Users can also download invoices from a platform server.

FIG. 16 illustrates a user interface conference equipment selection, according to some embodiments. As shown, once a guest has selected or clicked the invitation link to the conference, they are sent to or otherwise shown a meeting screen that displays equipment information. The user can then select their webcam, speaker, or other equipment system, enable/disable video and audio (e.g., mute), and set other equipment preferences, as appropriate.

FIG. 17 illustrates a user interface conference meeting display page, according to some embodiments. As shown, once a guest enters a meeting, they are able to view other participants and select options for video display, muting, presentation, exiting, chat, attendance list, and others, as appropriate.

FIG. 18 illustrates a user interface presentation mode page, according to some embodiments. As shown, a presentation mode can allow a user to view options for screensharing, select who can view, and modify appropriate settings.

FIG. 19 illustrates an example computer architecture for the application program 200 operated via the computing system 102. The computer system 102 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 102 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a videoconferencing module 210, a user module 212, a voucher module 214, a display module 216.

In some embodiments, the communication module 202 is configured for receiving, processing, and transmitting a user command and/or one or more data streams. In such embodiments, the communication module 202 performs communication functions between various devices, including the user computing device, the administrator computing device, and a third-party computing device. In some embodiments, the communication module 202 is configured to allow one or more users of the system, including a third-party, to communicate with one another. In some embodiments, the communications module 202 is configured to maintain one or more communication sessions with one or more servers, the administrative computing device, and/or one or more third-party computing device(s).

In some embodiments, the communication module 202 may be in operable communication with the voucher module 214 to transmit the voucher to the one or more guests.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the videoconferencing module 210 is configured to receive and permit the user to generate a videoconference invite, initiate a videoconference meeting, and otherwise allow users to interact via the videoconference.

In some embodiments, the user module 212 facilitates the creation of a user account for the application system. The user module 212 may allow the user to create a user profile which includes user information, user preferences, and user-associated information. The user module 212 may define the user's role (e.g., an administrator, employee, guest third-party, etc.).

In some embodiments, the voucher module 214 is operable to request a voucher from a third-party. Once the voucher is received from the third-party it may be transmitted to a guest to allow the guest to user the voucher as a currency to receive a service, or good (such as a food product).

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user (e.g., a voucher notification).

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A system for generating providing videoconferencing with meal delivery vouchers, comprising:
a device comprising:
a processor; and
a non-transitory, computer readable memory storing instructions that, when executed by the processor upon a user selection, cause the device to:
allow a manager to select a meeting time and send a voucher to one or more guests;
delivery the voucher to the guests via a network; and
provide a videoconference at the time the voucher has been exchanged for the delivery of food.

2. The system of claim 1, further comprising a voucher module for sending the voucher to the one or more guests.

3. The system of claim 1, further comprising a videoconferencing module to provide a video conference link via a videoconferencing link, wherein the videoconferencing link is selectable via the at least one guest.

4. The system of claim 1, further comprising a meeting list page to display a plurality of meetings.

5. The system of claim 1, further comprising a payment information page permitting the user to view and modify billing date ranges, view revenue, view meeting time, view total invoices, view user information, and view total used vouchers.

6. The system of claim 1, wherein the communication module delivers a voucher delivery notification to the user.

7. The system of claim 6, further comprising a meeting creating page to permit the user to generate the videoconference via providing a videoconference time and associating the at least one voucher with the videoconference.

8. A system for generating providing videoconferencing with meal delivery vouchers, comprising:
a device comprising:
a processor; and
a non-transitory, computer readable memory storing instructions that, when executed by the processor upon a user selection, cause the device to:
allow a manager to select a meeting time, via a videoconferencing module, and send a voucher, via a voucher module, to one or more guests;
deliver the voucher, via a communication module, to the guests via a network; and
provide a videoconference at the time the voucher has been exchanged for the delivery of food, wherein the videoconference is displayed via a display module.

9. The system of claim 8, further comprising a voucher module for sending the voucher to the one or more guests.

10. The system of claim 9, wherein the user pays the system on a per voucher transaction, per meeting transaction, per week, per month, or per quarter.

11. The system of claim 10, wherein the voucher is provided by a vendor via a third-party.

12. The system of claim 8, further comprising a videoconferencing module to provide a video conference link via a videoconferencing link, wherein the videoconferencing link is selectable via the at least one guest.

13. The system of claim 8, further comprising a meeting list page to display a plurality of meetings.

14. The system of claim 8, further comprising a payment information page permitting the user to view and modify billing date ranges, view revenue, view meeting time, view total invoices, view user information, view total used vouchers, and others. Users can also download invoices from a platform server.

15. The system of claim 8, wherein the communication module delivers a voucher delivery notification to the user.

16. The system of claim 15, further comprising a meeting creating page to permit the user to generate the videoconference via providing a videoconference time and associating the at least one voucher with the videoconference.

17. A method for generating and providing video conferencing with meal delivery vouchers, the method comprising the steps of:
selecting, via a manager to select a meeting time;
sending at least one voucher to at least one guest;
delivering, via a network, the at least one voucher to the at least one guest;
providing a videoconference at the time the voucher has been exchanged for the delivery of a food product.
